(19) United States
(12) Patent Application Publication
(10) Pub. No.: US 2006/0180410 A1
(43) Pub. Date: Aug. 17, 2006

(54) Oil brake driving device

(76) Inventor: Chih-Chen Juan, Taichung County (TW)

Correspondence Address: Keith Kline;PRO-TECHTOR INTERNATIONAL SERVICES, 20775 Norada Court, Saratoga, CA, 95070-3018, US

(21) Appl. No.: 11/058,454

(22) Filed: Feb. 14, 2005

(51) Int. Cl. F16D 55/18

(52) U.S. Cl. 188/72.4

(57) ABSTRACT

An oil brake driving device is used as a primary or a secondary part of an oil brake, comprising a main body, having a front end with an enclosed space and a rear end with a rear opening which is connected with the enclosed space; an expansion piece, placed in the enclosed space and having a pressure chamber and an opening; a connecting head, having a channel and a front end that is connected with the opening of the expansion piece and being fastened on the rear opening of the main body; and a piston on a front side of the expansion piece; wherein, when used as a primary part of an oil brake, for braking the piston is pushed rearward, generating oil pressure in the pressure chamber, which is transmitted through the connecting head and a conduit, and when used as a secondary part of an oil brake, oil pressure is by the conduit and the connecting head transmitted into the pressure chamber, causing the expansion piece to expand and the piston to be pushed forward.

### BACKGROUND OF THE INVENTION

1. Field of the Invention

The present invention relates to an oil brake driving device, particularly to an oil brake driving device which is not easily impaired by heat, dust and humidity and which avoids leaking of oil.

2. Description of Related Art

Brakes are indispensable structural parts of cars, motorcycles and bicycles. Simple structure, easy replaceability and easy checkability are common demands on vehicle brakes.

Among brakes for vehicles, oil brakes have the following advantages:

1. Brake discs and calipers are exposed in air and are therefore readily cooled.

2. Water on brake discs is centrifuged away, so does not impair effective braking.

3. High load is stably accommodated.

4. Stiffness is high.

Taiwan utility patent no. 165648 “Oil-pressure braking system”, as shown in FIG. 18, discloses an oil-pressure system having a primary part A and a secondary part B. The primary part A comprises: a housing 1; a handle 2, connected with the housing 1; a connecting rod 3; an oil-pressure vessel 4, mounted on the housing 1, having an oil-pressure outlet that is connected with a conduit 20; a piston 5 inside the oil-pressure vessel 4, driven by the handle 2 via the connecting rod 3 and pressing on oil in the oil-pressure vessel 4 at an end that carries a leather cap 6; a sealing ring 7, sealing the piston 5 against an inner wall of the oil-pressure vessel 4; and an oil container 8, set on the oil-pressure vessel 4 on a middle part thereof and used for refilling oil.

The conduit 20 leads to the secondary part B. The secondary part B comprises: a secondary oil-pressure vessel 10; two aligned pistons 11, glidingly movable along a main axis of the oil-pressure vessel 10 and having inner ends carrying leather caps 12; and two sealing rings, respectively sealing the pistons 11 against an inner wall of the secondary oil-pressure vessel 10.

The oil-pressure vessel 4, the piston 5, the leather cap 6 and the sealing ring 7 constitute the an active part of the oil-pressure system. The secondary oil-pressure vessel 10, the pistons 11, the leather caps 12 and the sealing rings 13 constitute a passive part of the oil-pressure system.

As shown in FIG. 19, the oil-pressure system just described is also used in conjunction with an oil-driven disc brake brake mounted on a motorcycle or a bicycle. The piston 11 has an outer end to which a caliper 14 is attached. For braking, the caliper 14 presses on a braking disc 21, and due to friction between the caliper 14 and the braking disc 21 a braking effect is achieved.

Conventional oil brakes have undergone many improvements, but a problem of leaking oil has not been satisfactorily resolved. Particular problems that still pervade are:

1. During braking, the sealing rings 7, 13 are subject to wear due to the movement of the pistons 5, 11 within the oil-pressure vessels 4, 10.

2. Heat causes the sealing rings 7, 13 to become brittle, so that oil leaks through.

3. Dust and sand easily damage the sealing rings 7, 13.

### SUMMARY OF THE INVENTION

It is an object of the present invention to provide an oil brake driving device which is not easily impaired by heat, dust and humidity.

Another object of the present invention is to provide an oil brake driving device which is not easily impaired by pressure.

A further object of the present invention is to provide an oil brake driving device which is not easily impaired by material wear.

The present invention can be more fully understood by reference to the following description and accompanying drawings.

### DETAILED DESCRIPTION OF THE PREFERRED EMBODIMENTS

The oil brake driving device of the present invention is used in conjunction with an oil brake mounted in a vehicle, like a bicycle, a motorcycle or a car. The oil brake driving device of the present invention is a primary part A as well as a secondary part B and comprises a main body 30; an expansion piece 50, set on the main body 30; a connecting head 40, mounted on the main body 30; and a piston 60, connected with a front end of the expansion piece 50. A more detailed description is given in the following.

As shown in FIGS. 1-5, the main body 30 has an enclosed space 31, from which a front opening 32 leads outwards. The expansion piece 50 is housed in the enclosed space 31, having a pressure chamber 51 and an opening 52 at a rear side thereof. The connecting head 40 has a channel 41 and a front end 42, which is fixed in the opening 52 of the expansion piece 50. Furthermore, the connecting head 40 has a rear end 43 connected with a conduit 20. The piston 60 has a rear end with a rear opening 61 set on the expansion piece 50 and a front end with a depression 62 carrying a caliper 64. Grooves 63 are cut into an outer periphery of the piston 60, allowing dust and water to be carried away.

A nut 44 on the connecting head 40 allows to fasten the connecting head and the expansion piece 50 on the main body 30.

The expansion piece 50 is elastically expandable and compressible, so that, when oil with high pressure flows through the conduit 20 and the channel 41 into the pressure chamber 51, the expansion piece 50 expands. The conduit 20 and the pressure chamber 51 form a closed oil system, with no oil touching the piston 60, so that oil leakage is avoided.

Referring to FIGS. 4 and 5, the secondary part B of the present invention is substituted for the piston 11, the leather cap 12 and the sealing ring 13 of conventional art described above. The depression 62 at the front end of the piston 60 carries the caliper 64. As shown in FIG. 4, when oil with high pressure (not shown) flows through the conduit 20 and the channel 41 into the pressure chamber 51, the expansion piece 50 expands, driving the caliper 64 in the depression 62 of the piston 60 on a brake disc 65, exerting a braking force thereon. As shown in FIG. 5, when pressure on oil in the pressure chamber 51 is released, the expansion piece 50 contracts due to elasticity, pulling back the piston 60, so that the caliper 64 retreats from the brake disc 65.

As above explanation shows, the present invention has the following advantages:

1. Pressure exerted within the pressure chamber 51 is uniformly distributed in the expansion piece 50, so that damage due to concentrated pressure is avoided.

2. Uniform distribution of pressure in the expansion piece 50 avoides material fatigue.

3. Since the conduit 20 and the expansion piece 50 form a closed, sealed system, no oil will leak out.

4. The expansion piece 50 and the piston 60 do not undergo material wear, so that a long lifespan thereof is ensured.

Referring to FIGS. 6 and 7, the present invention in a second embodiment has an expansion piece 50a with a pressure chamber 51a and a piston 60a. On operating a handle 2, a force is via a connecting rod 3 applied on the piston 60a, causing the expansion piece 50a to contract and oil in the pressure chamber 51a to be exposed to pressure. Oil subsequently flows from the pressure chamber 51a to an oil chamber 33 and further into the conduit 20, so that a braking force will be exerted.

On releasing the handle 2, the connecting rod 3 and thereby the piston 60a are pulled out, oil pressure in the expansion piece 50a and consequently in the oil chamber 33 decreases, so that no braking force is transmitted.

Referring to FIGS. 8 and 9, in a third embodiment of the present invention, a brake pedal 2a is substituted for the handle 2. Stepping on the brake pedal 2a pushes the piston 60a onto the expansion piece 50a and causes oil pressure in the expansion piece 50a and consequently in the conduit 20 to build up, so that a braking force will be exerted. On releasing the brake pedal 2a, the connecting rod 3 and thereby the piston 60a are pulled out, oil pressure in the expansion piece 50a and consequently in the oil chamber 33 decreases, so that no braking force is transmitted.

Referring to FIGS. 10 and 11, the present invention in a fourth embodiment is used in conjunction with a bicycle brake. Operating the handle 2 generates oil pressure in the conduit 20. Oil pressure is transmitted into a T-piece 83 and further into two connecting heads 40b and two expansion pieces 50b, resulting in two pistons 60b being pushed outward. The outward moving pistons 60b via two connecting rods 84 cause two pincer arms 85 to turn, pressing two calipers 87 against a rim 88 of a wheel, so that a braking effect is achieved. On releasing the handle 2, oil pressure in the expansion pieces 50b decreases, and a spring 86 pulls the pincer arms 85 and the pistons 60b back into original positions, so that the calipers 87 are separated from the rim 88 nad no braking is performed.

Referring to FIGS. 12 and 13, the present invention has either a single connecting head 40, expansion piece 50 and piston 60 or dual connecting heads 40, expansion pieces 50 and pistons 60. A main body 30c with according shape is used. As shown in FIG. 12, for reducing weight, on a bicycle or motorcycle preferably a single connecting head 40, expansion piece 50 and piston 60 is employed. As shown in FIG. 13, in a car preferably dual connecting heads 40, expansion pieces 50 and pistons 60 are installed for an increased braking effect.

Referring to FIG. 14, in another embodiment of the present invention, the expansion piece 50 has bellows 53 on a periphery for increased flexibility in a preferred direction.

Referring to FIGS. 15-17, the present invention in a fifth embodiment comprises: a main body 30d with an inner space 34 which houses an expansion piece 50d with a pressure chamber 51d; a pressing plate 90, having a central hole 91 that connects with the pressure chamber 51d and being attached to a rear side of the expansion piece 50d by screws 93; a connecting head 40d, fastened to the hole 91 and having a channel 41d which is connected with the pressure chamber 51d; and a piston 60d, which is set on a front side of the expansion piece 50d.

As shown in FIG. 16, when oil of high pressure flows through the channel 41d into the pressure chamber 51d, the expansion piece 50d expands, pushing the piston 60d and a caliper 64d set on a front end thereof to exert a braking force.

As shown in FIG. 17, to cease braking, oil pressure in the pressure chamber 51d is released, the expansion piece 50d contracts, pulling back the piston 60d and the caliper 64d.

In the fifth embodiment of the present invention, the main body 30d and the expansion piece 50d are simplified structural parts. The pressing plate 90 seals the expansion piece 50d against the outside thereof, preventing oil from leaking out.

As above explanation shows, the present invention is resistant against heat, water and dust and is usable in all kinds of vehicles, overcoming the deficiencies of conventional art.

While the invention has been described with reference to preferred embodiments thereof, it is to be understood that modifications or variations may be easily made without departing from the spirit of this invention which is defined by the appended claims.

### BRIEF DESCRIPTION OF THE DRAWINGS

FIG. 1 is a perspective view of the oil brake driving device of the present invention.

FIG. 2 is a perspective view of the oil brake driving device of the present invention when dissassembled.

FIG. 3 is a sectional view of the oil brake driving device of the present invention.

FIG. 4 is a schematic illustration of the oil brake driving device of the present invention during braking.

FIG. 5 is a schematic illustration of the oil brake driving device of the present invention during releasing.

FIG. 6 is a schematic illustration of the oil brake driving device of the present invention in the second embodiment during braking.

FIG. 7 is a schematic illustration of the oil brake driving device of the present invention in the second embodiment during releasing.

FIG. 8 is a schematic illustration of the oil brake driving device of the present invention in the third embodiment during braking.

FIG. 9 is a schematic illustration of the oil brake driving device of the present invention in the third embodiment during releasing.

FIG. 10 is a schematic illustration of the oil brake driving device of the present invention in the fourth embodiment during braking.

FIG. 11 is a schematic illustration of the oil brake driving device of the present invention in the fourth embodiment during releasing.

FIG. 12 is a schematic illustration of the oil brake driving device of the present invention with a single connecting head, expansion piece and piston.

FIG. 13 is a schematic illustration of the oil brake driving device of the present invention with dual connecting heads, expansion pieces and pistons.

FIG. 14 is a sectional view of the connecting head and expansion piece of the present invention in another embodiment.

FIG. 15 is a perspective view of the oil brake driving device of the present invention in the fifth embodiment.

FIG. 16 is a schematic illustration of the oil brake driving device of the present invention in the fifth embodiment during braking.

FIG. 17 is a schematic illustration of the oil brake driving device of the present invention in the fifth embodiment during releasing.

FIG. 18 is a schematic illustration of a conventional oil rim brake in a rest state.

FIG. 19 is a schematic illustration of a conventional oil disc brake during braking.

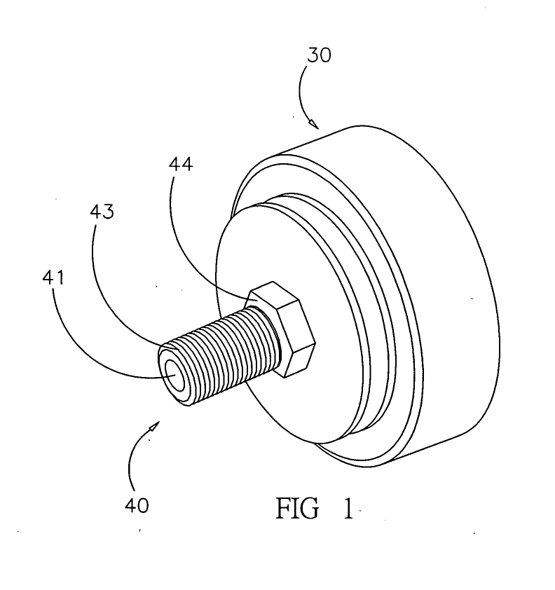

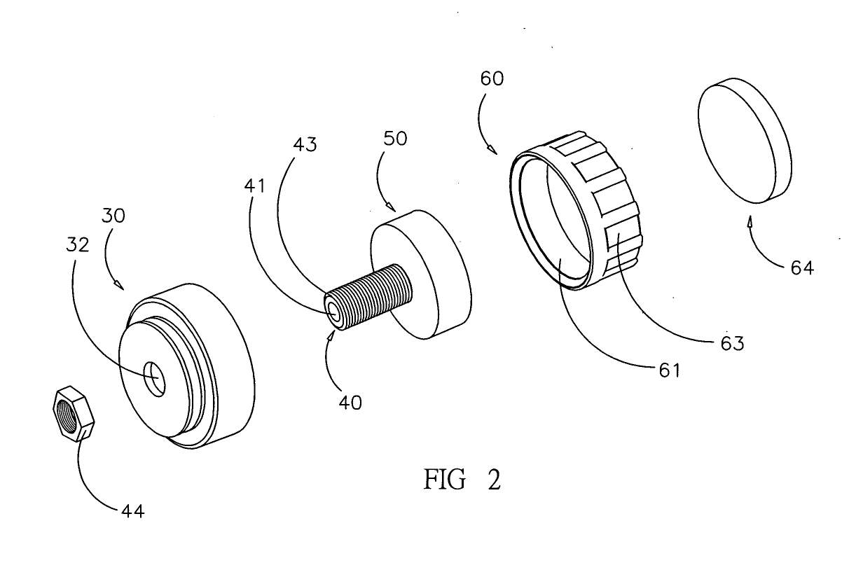

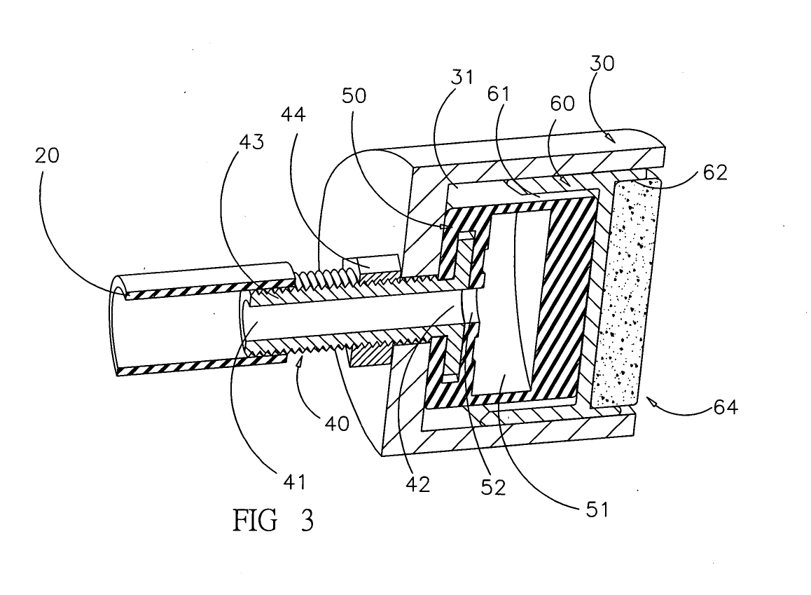

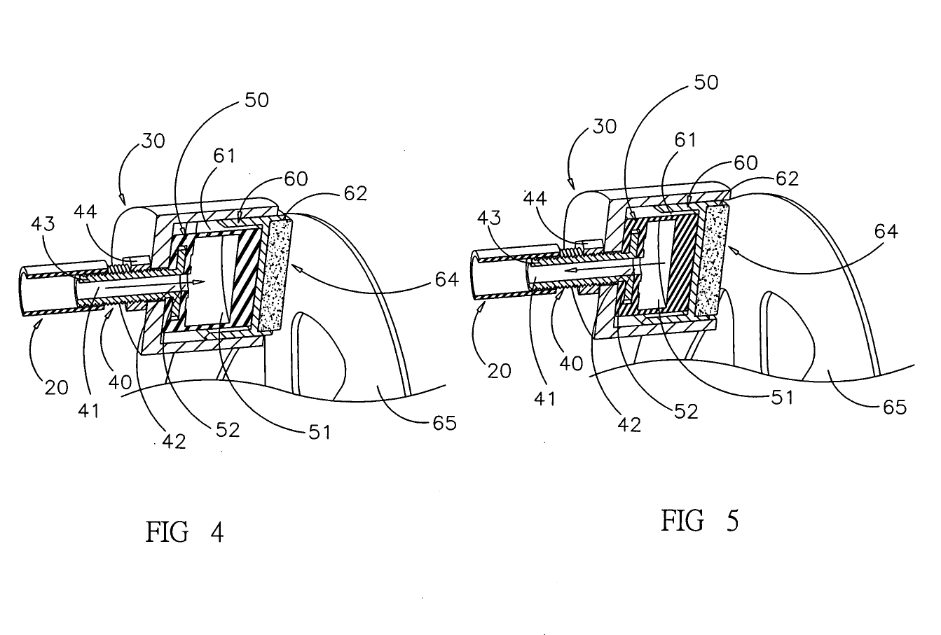

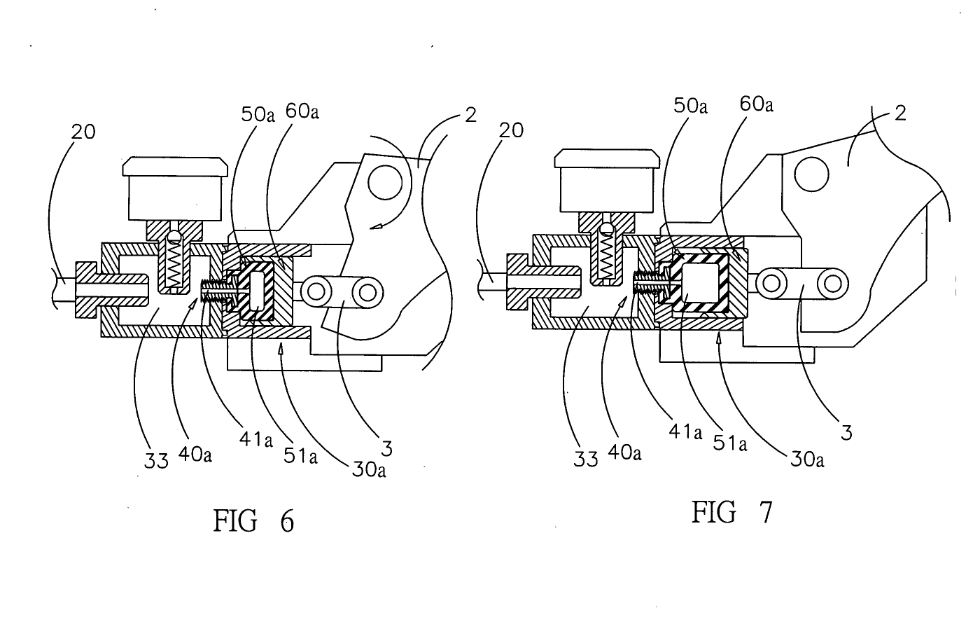

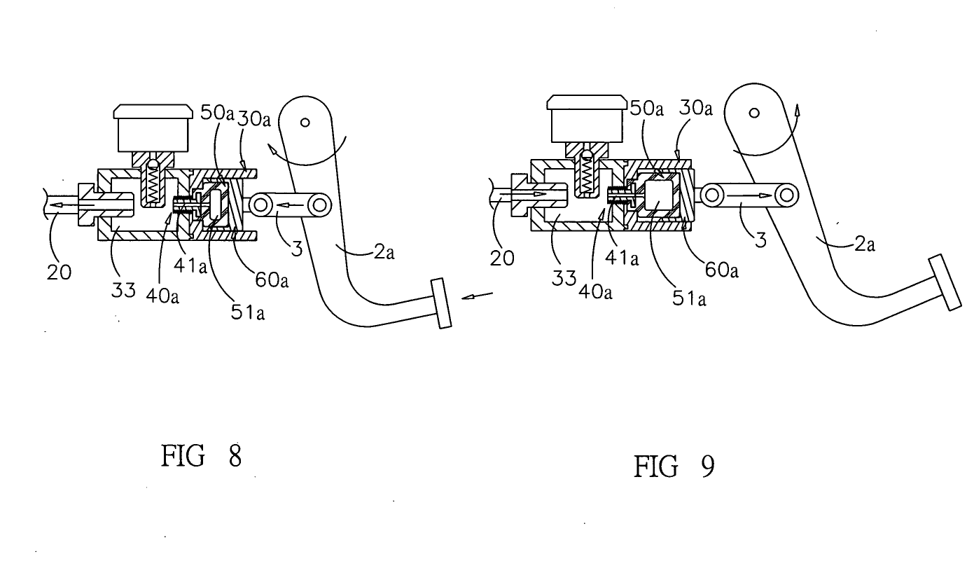

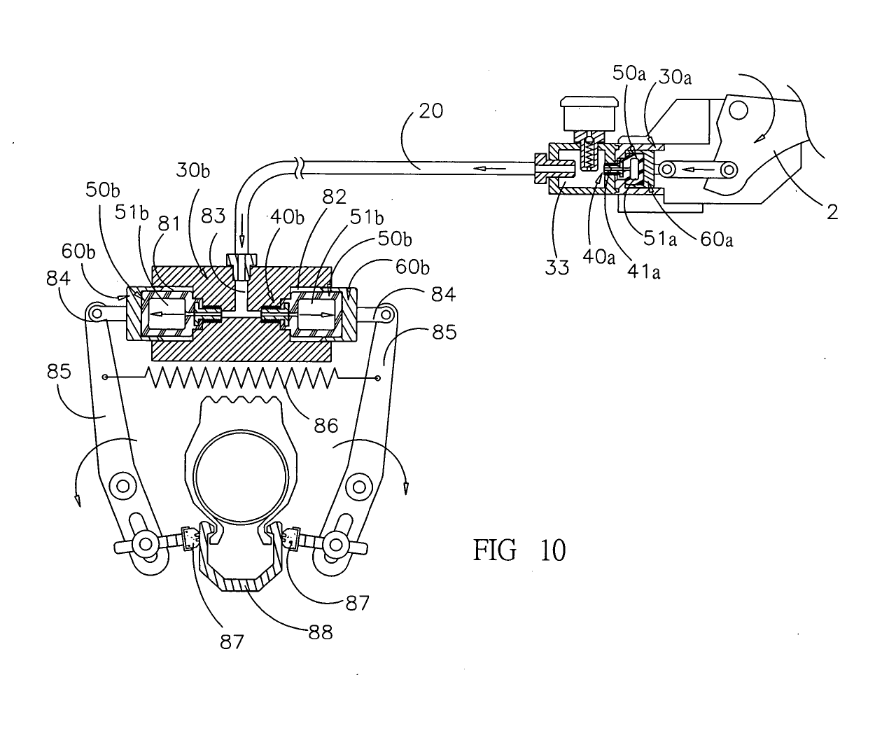

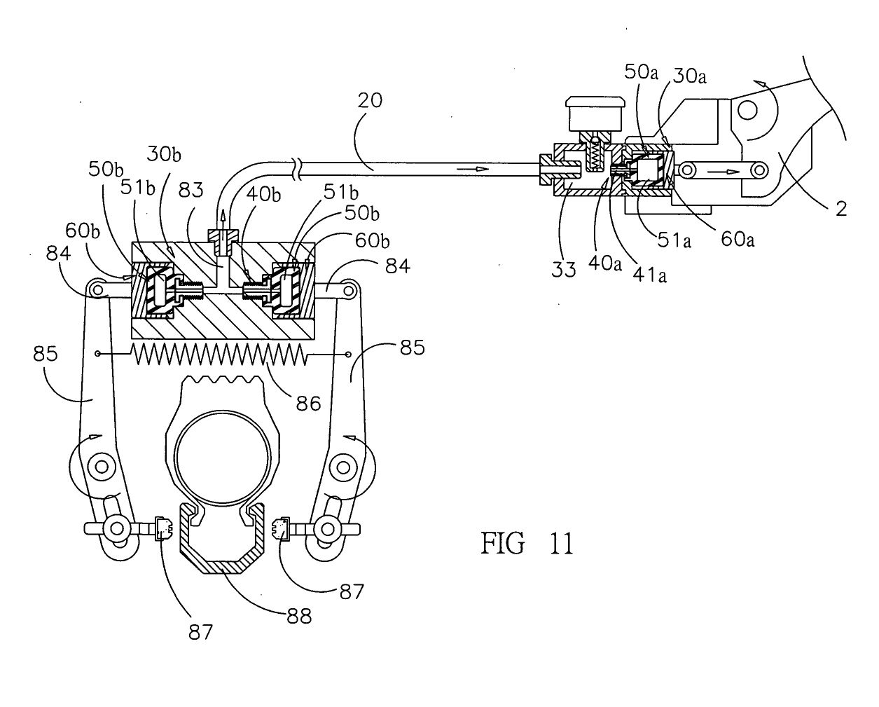

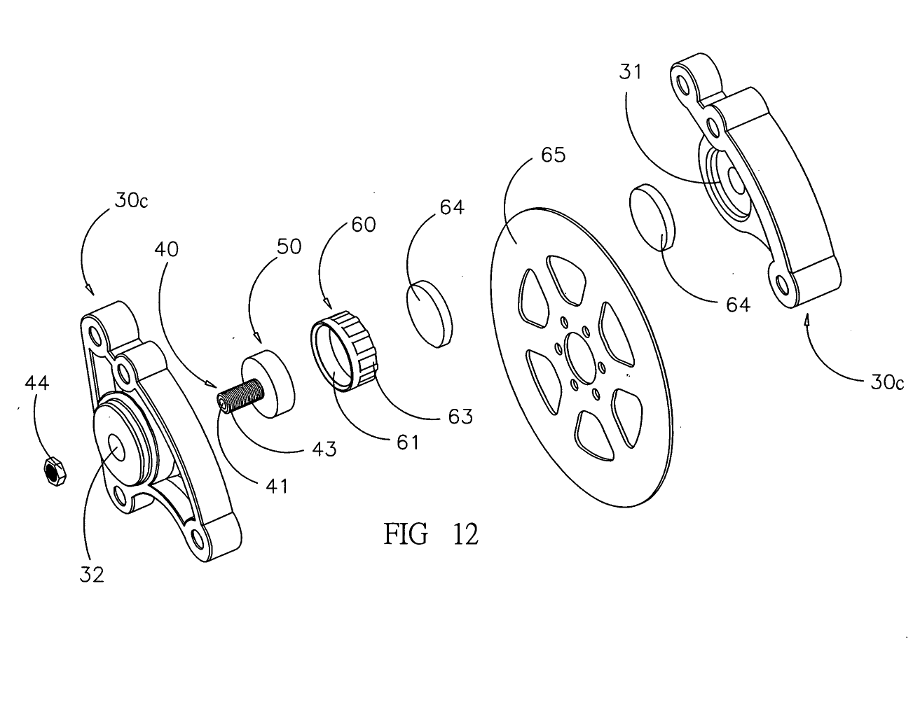

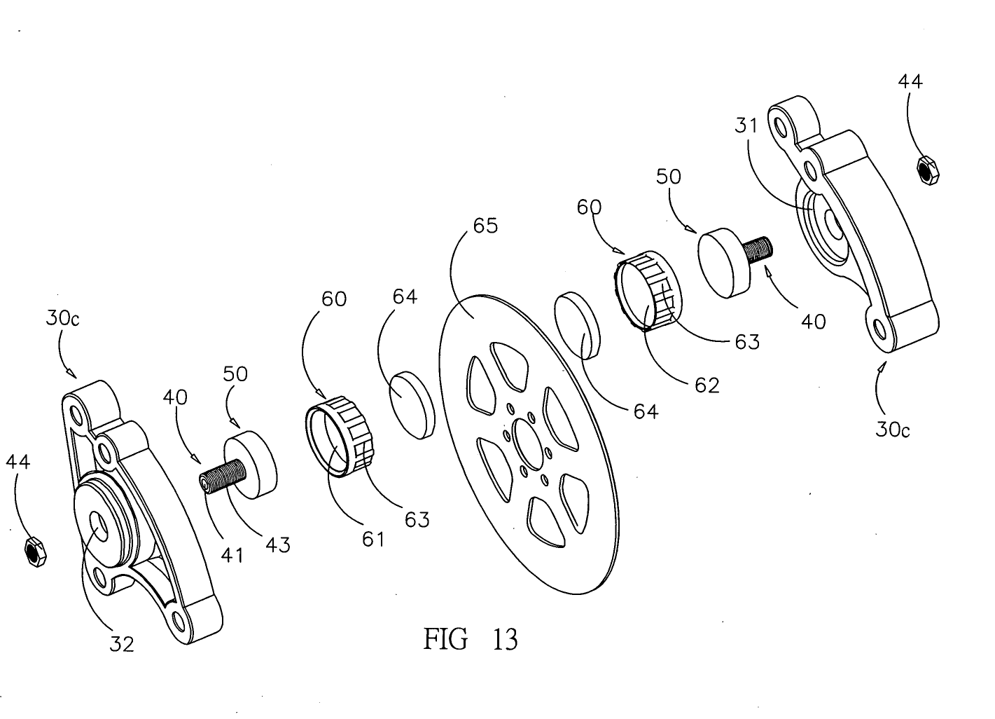

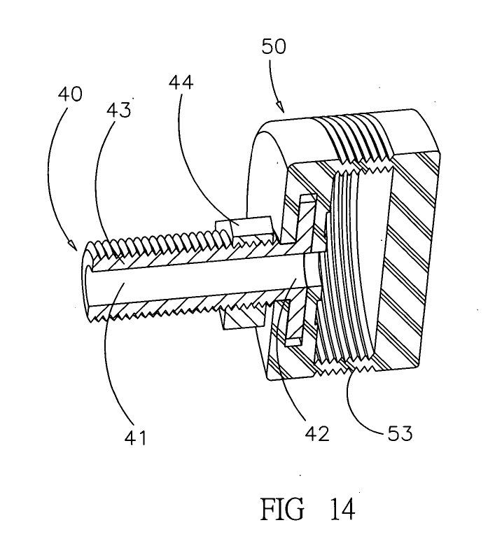

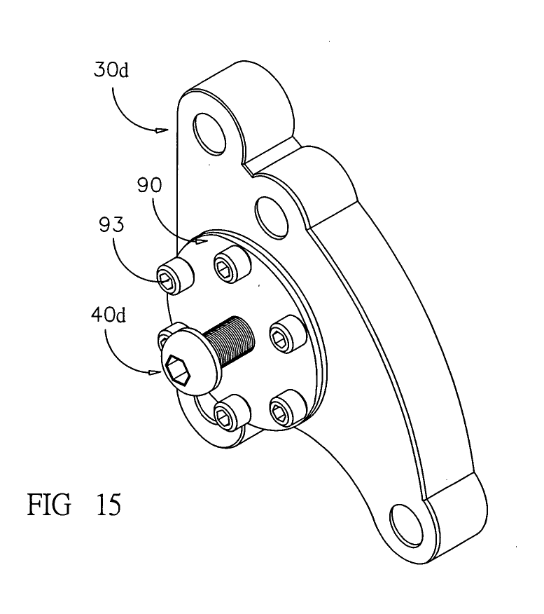

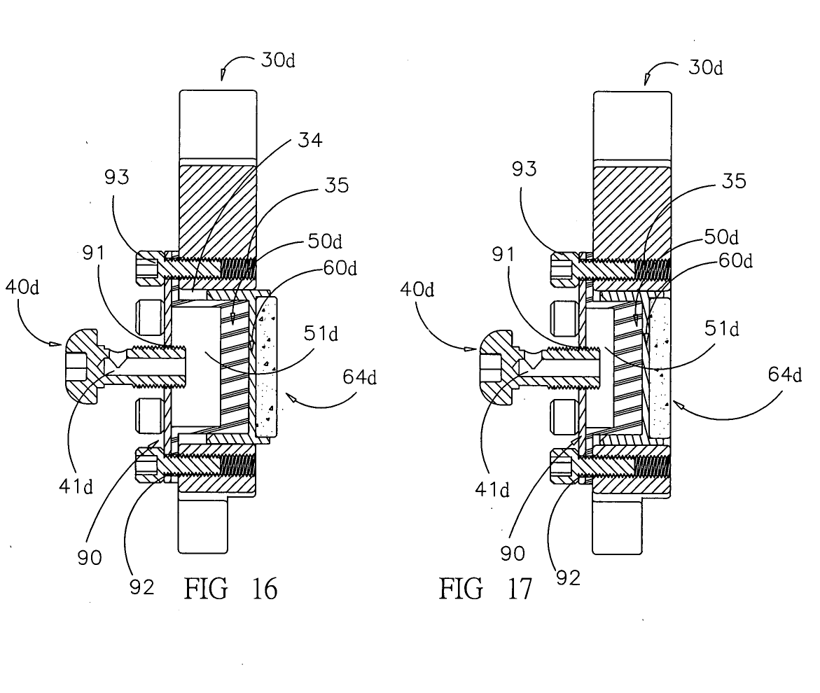

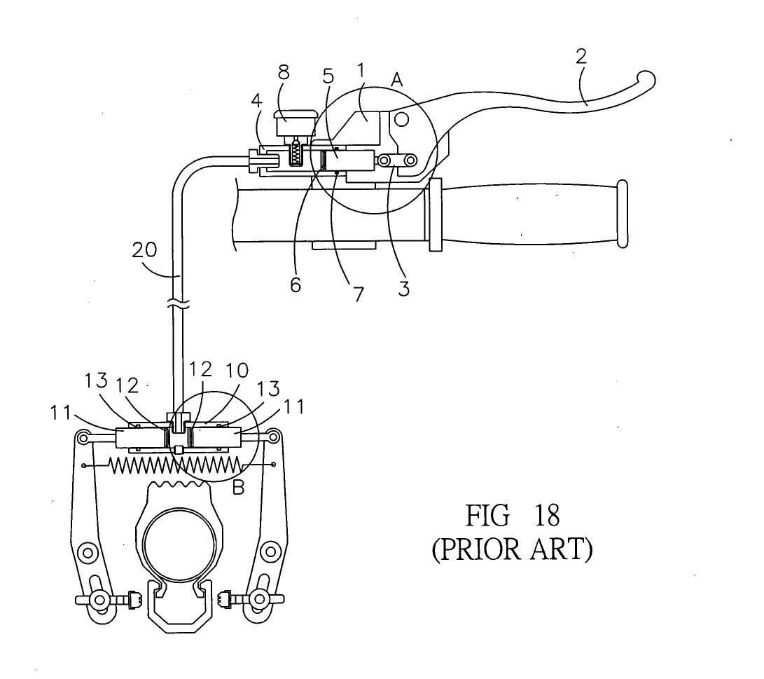

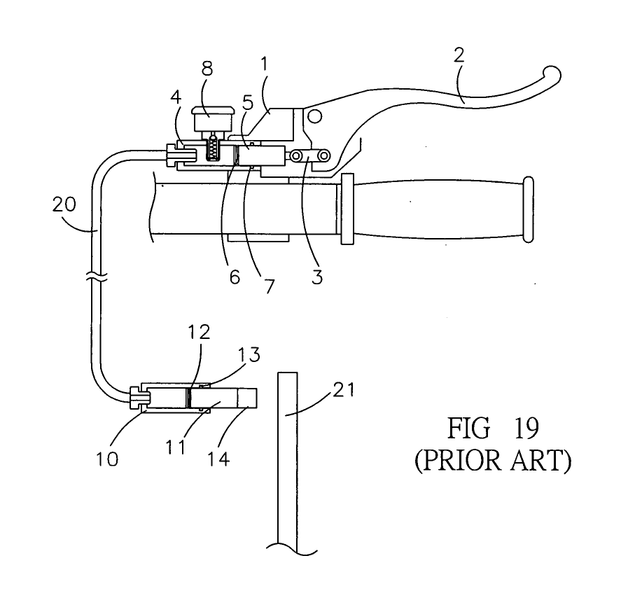

1. An oil brake driving device, comprising:
a main body, having a front end with an enclosed space and a rear end with a rear opening which is connected with said enclosed space;
an expansion piece, placed in said enclosed space and having a pressure chamber and an opening; and
a connecting head, having a channel and a front end that is connected with said opening of said expansion piece and being fastened on said rear opening of said main body.

2. The oil brake driving device according to claim 1, wherein said connecting head and said expansion piece are integrated into a single body.

3. The oil brake driving device according to claim 1, wherein said connecting head and said expansion piece are fastened to said main body by screws.

4. The oil brake driving device according to claim 1, wherein said expansion piece has a front side on which a piston is set.

5. The oil brake driving device according to claim 4, wherein said piston carries a caliper.

6. The oil brake driving device according to claim 4, wherein said piston has a cross-section shaped like the letter H.

7. The oil brake driving device according to claim 4, wherein said piston has a cross-section shaped like the letter U.

8. The oil brake driving device according to claim 1, wherein said expansion piece has a periphery with bellows.

9. An oil brake driving device, comprising:
a main body, having a front end and an enclosed space;
an expansion piece, placed in said front end of said main body and having a rear side;
a pressure plate, attached to said rear side of said expansion piece and having a hole; and
a connecting head, having a channel and a front end that is connected with said expansion piece and being fastened on said hole of said pressing plate.

10. The oil brake driving device according to claim 9, wherein said expansion piece has a pressure chamber.

11. The oil brake driving device according to claim 9, wherein said expansion piece has a front side on which a piston is set.

12. The oil brake driving device according to claim 10, wherein said piston carries a caliper.

13. The oil brake driving device according to claim 10, wherein said piston has a cross-section shaped like the letter H.

14. The oil brake driving device according to claim 10, wherein said piston has a cross-section shaped like the letter U.

15. The oil brake driving device according to claim 9, wherein said expansion piece has a periphery with bellows.
